(19) United States
(12) Patent Application Publication
(10) Pub. No.: US 2026/0274871 A1
(43) Pub. Date: Sep. 17, 2026

(54) METHOD FOR DIMENSIONAL TRANSFORMATION OF METAL-ORGANIC FRAMEWORK CRYSTAL

(71) Applicant: Huzhou College, Huzhou City (CN)

(72) Inventors: Hongfeng LI, Huzhou City (CN); Yichao CHEN, Huzhou City (CN); Yunlian ZHONG, Huzhou City (CN); Fan LEI, Huzhou City (CN); Qingyu WANG, Huzhou City (CN)

(73) Assignee: Huzhou College, Huzhou City, ZJ (CN)

(21) Appl. No.: 19/232,240

(22) Filed: Jun. 9, 2025

(30) Foreign Application Priority Data
Mar. 17, 2025 (CN) 202510317657.9

(51) Int. Cl. C07F 3/06; B82Y 40/00; C07F 1/08; C07F 15/06; C09K 11/02; C09K 11/06

(52) U.S. Cl. CPC C07F 3/06; C07F 1/08; C07F 15/06; C09K 11/02; C09K 11/06; B82Y 40/00; C09K 2211/1007

(57) ABSTRACT

Provided is a method for dimensional transformation of a metal-organic framework (MOF). The method includes: introducing a two-dimensional-layered MOF in a mixed solvent and heating to obtain a three-dimensional MOF; where an organic ligand of the two-dimensional-layered MOF is selected from the group consisting of 1,4-benzenedicarboxylic acid and 2-hydroxyterephthalic acid; a metal ion of the two-dimensional-layered MOF is selected from the group consisting of Zn²⁺, Co²⁺, and Cu²⁺; and the mixed solvent includes alcohol and N,N-dimethylformamide (DMF).

### CROSS REFERENCE TO RELATED APPLICATION

This patent application claims the benefit and priority of Chinese Patent Application No. 202510317657.9 filed with the China National Intellectual Property Administration on Mar. 17, 2025, the disclosure of which is incorporated by reference herein in its entirety as part of the present application.

### TECHNICAL FIELD

The present disclosure belongs to the technical field of porous crystalline material preparation, and in particular relates to a method for dimensional transformation of a metal-organic framework (MOF).

### BACKGROUND

In recent years, with the rise of two-dimensional materials such as graphene, MXene, black phosphorus, and metal sulfides as well as the deepening research into metal-organic frameworks (MOFs), there has been growing interest in two-dimensional MOF materials, which broadly include layered MOF nanosheets.

Two-dimensional MOFs can generally be prepared via top-down and bottom-up approaches. The top-down approach involves exfoliating pre-existing three-dimensional bulk MOFs into nanosheets through methods such as ultrasonication, ion intercalation, grinding, or electrochemical delamination. The bottom-up approach refers to the direct synthesis of two-dimensional MOFs by precisely controlling the reaction between metal ions and organic ligands through strategies like adjusting reactant concentrations, introducing surfactants, or employing competitive ligands. The exceptional properties of two-dimensional MOFs stem from their unique two-dimensional architecture, which not only retains the intrinsic advantages of MOFs but also endows them with enhanced physical flexibility, ultrathin morphology, high surface energy, and abundant exposed active sites. For instance, the research group led by Zhang Hua at the City University of Hong Kong has developed a surfactant-assisted synthesis strategy. By using polyvinylpyrrolidone (PVP) to confine the growth of Zn-TCPP along the Z-axis, MOF nanosheets are successfully fabricated with a thickness of approximately 7.4 nm. Due to the structural advantages, such a material demonstrates exceptional performance as a fluorescent DNA detection platform. Numerous studies highlight that two-dimensional MOFs possess distinct advantages over their three-dimensional MOFs, making the two-dimensional MOFs a promising frontier for further exploration and application development.

In MOFs research, significant efforts have focused on leveraging their intrinsic porosity and size-selective properties to encapsulate functional substances, such as metal nanoparticles, oxides, up-conversion nanoparticles, organic molecules, and biocatalysts. Commonly employed encapsulation strategies include capillary absorption, post-synthetic modification, and in situ encapsulation. However, these approaches face limitations such as size-matching challenges, tedious modification procedures, and deactivation of active species, making the development of novel MOFs encapsulation strategies a critical and ongoing challenge.

### SUMMARY

An object of the present disclosure is to provide a method for dimensional transformation of an MOF. This method achieves the dimensionality transformation of MOF materials through a one-step method, characterized by simplicity in process, excellent controllability, while simultaneously enabling the encapsulation of functional nanoparticles.

To achieve the above object, the present disclosure provides the following technical solutions:

The present disclosure provides a method for dimensional transformation of an MOF, including the following steps:
introducing a two-dimensional-layered MOF in a mixed solvent and heating to obtain a three-dimensional MOF; where
an organic ligand of the two-dimensional-layered MOF is selected from the group consisting of 1,4-benzenedicarboxylic acid and 2-hydroxyterephthalic acid;
a metal ion of the two-dimensional-layered MOF is selected from the group consisting of Zn²⁺, Co²⁺, and Cu²⁺; and
the mixed solvent includes alcohol and N,N-dimethylformamide (DMF).

In some embodiments, the alcohol is selected from the group consisting of methanol, ethanol, and n-propanol.

In some embodiments, a volume ratio of the alcohol to the DMF is in a range of (0.5-3):1.

In some embodiments, the volume ratio of the alcohol to the DMF is 1:1.

In some embodiments, the heating is conducted at a temperature of 30° C. to 100° C. for 12 h to 48 h.

The present disclosure further provides a process for encapsulating nanoparticles using the method for dimensional transformation of the MOF as described above, including the following steps:
mixing the two-dimensional-layered MOF, the nanoparticles, and the mixed solvent to obtain a dispersion; and
standing the dispersion, and then heating to obtain a nanoparticle-encapsulated three-dimensional MOF; where
the organic ligand of the two-dimensional-layered MOF is selected from the group consisting of the 1,4-benzenedicarboxylic acid and the 2-hydroxyterephthalic acid;
a metal ion of the two-dimensional-layered MOF is selected from the group consisting of the Zn²⁺, the Co²⁺, and the Cu²⁺;
the mixed solvent includes the alcohol and the DMF; and
the nanoparticles have an average particle size less than 20 nm.

In some embodiments, the nanoparticles are at least one selected from the group consisting of metal nanoparticles, an organic fluorescent molecule, and a metal compound.

In some embodiments, the metal nanoparticles are at least one selected from the group consisting of Au nanoparticles, Pt nanoparticles, and Pb nanoparticles.

In some embodiments, the organic fluorescent molecule is at least one selected from the group consisting of Rhodamine B, perylene, p-diethoxybenzene, and bromophenol blue.

The present disclosure further provides a nanoparticle-encapsulated three-dimensional MOF prepared by the process as described above, where the nanoparticle-encapsulated three-dimensional MOF includes the three-dimensional MOF and the nanoparticles that are distributed in porous cavities and channels of the three-dimensional MOF.

The present disclosure provides a method for dimensional transformation of a MOF, including the following steps: introducing a two-dimensional-layered MOF in a mixed solvent and heating to obtain a three-dimensional MOF; where an organic ligand of the two-dimensional-layered MOF is selected from the group consisting of 1,4-benzenedicarboxylic acid and 2-hydroxyterephthalic acid; a metal ion of the two-dimensional-layered MOF is selected from the group consisting of Zn²⁺, Co²⁺, and Cu²⁺; and the mixed solvent includes alcohol and DMF. In the present disclosure, the dimensional transformation from two-dimensional MOFs to three-dimensional MOFs is achieved through a fusion-reconstruction process. Under the polarity regulation of a dual-solvent system, the two-dimensional MOFs gradually dissolve, fuse, and undergo stacked growth during solvent interaction, ultimately forming structurally stable three-dimensional bulk crystals. As a result, the method according to the present disclosure demonstrates novelty in strategy, simplicity, and high efficiency. Moreover, by introducing nanoparticles into the system prior to transformation, nanoparticle encapsulation can be simultaneously accomplished. Critically, the high surface energy of two-dimensional MOFs drives nanoparticles to preferentially adsorb onto their surfaces in the mixed solvent system. During the dual-solvent-driven transformation, these nanoparticles are encapsulated within the crystal lattice of the three-dimensional MOFs, enabling the construction of multifunctional three-dimensional MOF composites. The method according to the present disclosure does not require modification of the nanoparticles and does not have the defect of difficult size matching, thus showing desirable controllability and a large encapsulation volume.

### BRIEF DESCRIPTION OF THE DRAWINGS

To describe the technical solutions in embodiments of the present disclosure or in the prior art more clearly, the accompanying drawings required for the embodiments are briefly described below. Apparently, the accompanying drawings in the following description show merely some embodiments of the present disclosure, and those of ordinary skill in the art may still derive other accompanying drawings from these accompanying drawings without inventive efforts.

FIG. 1A shows the scanning electron microscopy (SEM) images of two-dimensional CuBDC (BDC: 1,4-benzenedicarboxylate), FIG. 1B shows the scanning electron microscopy (SEM) images of two-dimensional ZnBDC, and FIG. 1C shows the scanning electron microscopy (SEM) images of two-dimensional CoBDC;

FIG. 2A shows the SEM images of three-dimensional CuBDC after the transformation of two-dimensional MOF nanosheets, FIG. 2B shows the SEM images of three-dimensional ZnBDC after the transformation of two-dimensional MOF nanosheets, and FIG. 2C shows the SEM images of three-dimensional CoBDC after the transformation of two-dimensional MOF nanosheets;

FIG. 3A shows the SEM image of three-dimensional ZnBDC, FIG. 3B shows the X-ray diffraction (XRD) pattern of three-dimensional ZnBDC, and FIG. 3C shows the N₂ adsorption isotherm of three-dimensional ZnBDC;

FIG. 4A to FIG. 4F show the time-tracked SEM image of a ZnBDC dual-solvent transformation process, where FIG. 4A, FIG. 4B, FIG. 4C, FIG. 4D, FIG. 4E, and FIG. 4F correspond to 0 h, 2 h, 4 h, 6 h, 12 h, and 24 h, respectively;

FIG. 5A shows the transmission electron microscopy (TEM) image of Au nanoparticles, FIG. 5B shows the SEM image of three-dimensional ZnBDC encapsulated with Au nanoparticles, FIG. 5C shows the TEM image of three-dimensional ZnBDC encapsulated with Au nanoparticles, and FIG. 5D shows the XRD pattern of three-dimensional ZnBDC encapsulated with Au nanoparticles; and

FIG. 6A shows the SEM image of three-dimensional ZnBDC encapsulated with p-diethoxybenzene and FIG. 6B shows the fluorescence spectrum of three-dimensional ZnBDC encapsulated with p-diethoxybenzene.

### DETAILED DESCRIPTION

The present disclosure provides a method for dimensional transformation of a MOF, including the following steps:
introducing a two-dimensional-layered MOF in a mixed solvent and heating to obtain a three-dimensional MOF; where an organic ligand of the two-dimensional-layered MOF is selected from the group consisting of 1,4-benzenedicarboxylic acid and 2-hydroxyterephthalic acid; a metal ion of the two-dimensional-layered MOF is selected from the group consisting of Zn²⁺, Co²⁺, and Cu²⁺; and the mixed solvent includes (consists of) alcohol and DMF.

As an embodiment of the present disclosure, the organic ligand of the two-dimensional-layered MOF is 1,4-benzenedicarboxylic acid (H₂BDC) or 2-hydroxyterephthalic acid; the metal ion of the two-dimensional-layered MOF includes Zn²⁺, Co²⁺, or Cu²⁺; in an embodiment of the present disclosure, ZnBDC is specifically taken as an example for illustration.

As an embodiment of the present disclosure, there is no special limitation on the source of the two-dimensional-layered MOF, which may be commercially available or self-prepared; there is no special limitation on the preparation method, which can be conducted using common techniques in the field such as the interface method, the layered self-assembly method, or the surface modification method. In an embodiment of the present disclosure, the interface method is specifically taken as an example for illustration.

As an embodiment of the present disclosure, the mixed solvent includes (consists of) alcohol and DMF; the alcohol includes methanol, ethanol, or n-propanol, and in an embodiment, the methanol is specifically taken as an example for illustration. As an embodiment, a volume ratio of the alcohol to the DMF is in a rang of (0.5-3):1, specifically 1:1. Maintaining the volume ratio of the alcohol to the DMF within the aforementioned range in the embodiment facilitates vapor pressure equilibrium within the container during the transformation and enhances the synergistic effects of solvents with different polarities.

As an embodiment of the present disclosure, the heating is conducted at a temperature of 30° C. to 100° C., specifically 30° C., 60° C., or 80° C. for 12 h to 48 h, specifically 24 h; as an embodiment, a heating rate to reach a heating temperature is in a range of 2° C./min to 10° C./min, specifically 5° C./min. As an embodiment, the heating is conducted by heating statically a resulting reaction system in an oven. Maintaining the heating parameters within the aforementioned range in the embodiment facilitates achieving a stable and complete final transformation.

As an embodiment of the present disclosure, the method further includes after the heating, separating a resulting solid-liquid system, followed by washing a resulting solid-phase product with methanol and drying to obtain the three-dimensional MOF.

As an embodiment of the present disclosure, the separating is conducted by centrifugation. There is no particular limitation on the centrifugation and drying, as long as a dry three-dimensional MOF can be obtained.

The present disclosure further provides a process for encapsulating nanoparticles using the method for dimensional transformation of the MOF as described above, including the following steps:
mixing the two-dimensional-layered MOF, the nanoparticles, and the mixed solvent to obtain a dispersion; and standing the dispersion, and then heating to obtain a nanoparticle-encapsulated three-dimensional MOF; where
the organic ligand of the two-dimensional-layered MOF is selected from the group consisting of the 1,4-benzenedicarboxylic acid and the 2-hydroxyterephthalic acid; a metal ion of the two-dimensional-layered MOF is selected from the group consisting of the Zn²⁺, the Co²⁺, and the Cu²⁺; the mixed solvent includes (consists of) the alcohol and the DMF; and the nanoparticles have an average particle size less than 20 nm.

As an embodiment of the present disclosure, the nanoparticles have an average particle size less than 20 nm; the source of the nanoparticles is not particularly limited and may be commercially available or self-prepared, with no specific restrictions imposed on the self-preparation methods as long as they employ preparation techniques well-known to those skilled in the art. As an embodiment, the nanoparticles are at least one selected from the group consisting of metal nanoparticles, an organic fluorescent molecule, and a metal compound; the metal nanoparticles are at least one selected from the group consisting of Au nanoparticles, Pt nanoparticles, and Pb nanoparticles, and in an embodiment, Au nanoparticles are specifically taken as an example for illustration; the organic fluorescent molecule is at least one selected from the group consisting of Rhodamine B, perylene, p-diethoxybenzene, and bromophenol blue, with p-diethoxybenzene specifically exemplified in an embodiment; the metal compound is at least one selected from the group consisting of cadmium sulfide and ferric oxide. Maintaining the nanoparticle size within the aforementioned range in the embodiment facilitates improved encapsulation effectiveness while preserving the structural integrity of the host MOF materials.

The present disclosure further provides a nanoparticle-encapsulated three-dimensional MOF prepared by the process as described above. As an embodiment, the nanoparticle-encapsulated three-dimensional MOF includes the three-dimensional MOF and the nanoparticles that are distributed in porous cavities and channels of the three-dimensional MOF. As an embodiment, the nanoparticles in the nanoparticle-encapsulated three-dimensional MOF have a loading capacity of 5 wt. % to 10 wt. %, and 5 wt. % and 8 wt. % are specifically used as examples for illustration.

In some embodiments of the present disclosure, the three-dimensional MOF refers to MOF with minimal variation in crystal dimensionality parameters (length, width, and height) across three dimensions and possessing regular crystal morphologies such as octahedral or cubic. In an embodiment, the octahedral morphology is specifically taken as an example for illustration.

In order to further illustrate the present disclosure, the technical solutions provided by the present disclosure are described in detail below in connection with accompanying drawings and examples, but these examples should not be understood as limiting the scope of the present disclosure.

### Example 1

### 1. i) Preparation of Two-Dimensional ZnBDC Nanosheets

10 mg of Zn(Ac)₂·2H₂O was dissolved in a mixed solvent of 2 mL CH₃CN and 1 mL DMF, designated as solution A. A mixed solvent of 1 mL CH₃CN and 1 mL DMF was prepared by mixing, designated as solution B. 10 mg of H₂BDC was dissolved in a mixed solvent of 1 mL CH₃CN and 2 mL DMF, designated as solution C. In a 15 mL round-bottom flask, the solution A was first added, followed by a slow addition of the solution B along the flask wall using a separatory funnel, and finally the solution C was gradually added via the separatory funnel. After completion of additions, a reaction was conducted statically in an oven at 40° C. for 24 h. Upon the reaction completion, a resulting reaction product was centrifuged, and a resulting solid phase was washed with DMF and ethanol in sequence and then dried to obtain the two-dimensional ZnBDC nanosheets.

### ii) Preparation of Three-Dimensional ZnBDC

10 mg of the two-dimensional ZnBDC nanosheets was dispersed in a small glass vial containing 2 mL methanol and 2 mL DMF, and a resulting mixture was reacted in an oven at 80° C. for 24 h. A resulting reaction product was centrifuged, and a resulting solid phase was washed with methanol and dried to obtain the three-dimensional ZnBDC.

### 2. i) Preparation of Two-Dimensional CuBDC Nanosheets

The procedure was the same as the preparation of two-dimensional ZnBDC nanosheets, except that Zn(Ac)₂·2H₂O was replaced with Cu(Ac)₂·2H₂O.

### ii) Preparation of Three-Dimensional CuBDC

The procedure was the same as the preparation of three-dimensional ZnBDC, except that the two-dimensional ZnBDC nanosheets were replaced with the two-dimensional CuBDC nanosheets.

### 3. i) Preparation of Two-Dimensional CoBDC Nanosheets

The procedure was the same as the preparation of two-dimensional ZnBDC nanosheets, except that Zn(Ac)₂·2H₂O was replaced with Co(Ac)₂·2H₂O.

### ii) Preparation of Three-Dimensional CoBDC

The procedure was the same as the preparation of three-dimensional ZnBDC, except that the two-dimensional ZnBDC nanosheets were replaced with the two-dimensional CoBDC nanosheets.

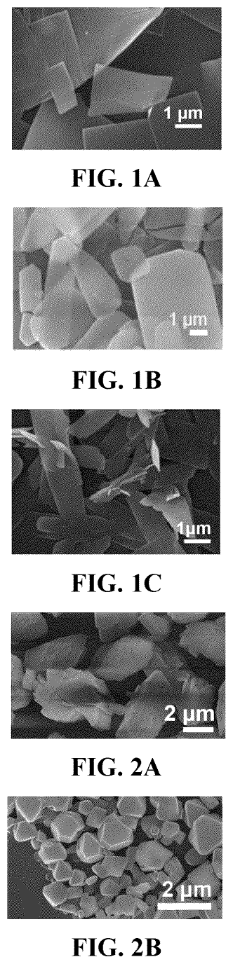

FIG. 1B shows the SEM image of the two-dimensional ZnBDC nanosheets, revealing their two-dimensional layered morphology. FIG. 1A and FIG. 1C show the SEM images of two-dimensional CuBDC and two-dimensional CoBDC, respectively, demonstrating that CuBDC and CoBDC also exhibit two-dimensional layered morphologies.

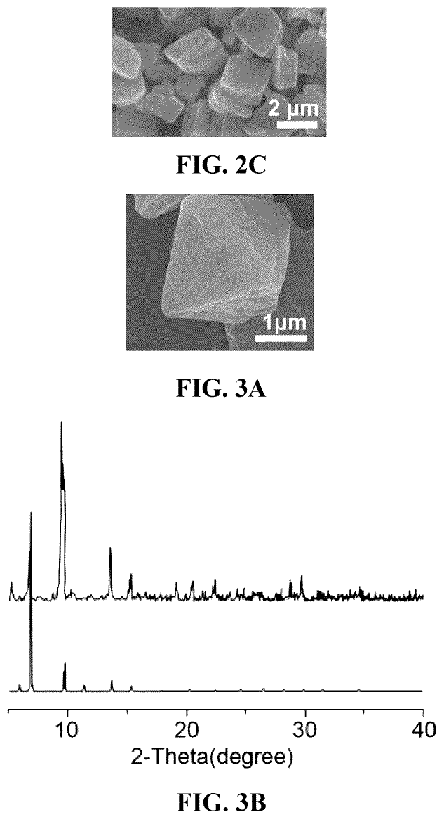

FIG. 2A to FIG. 2C show the SEM images of the three-dimensional MOFs transformed from two-dimensional nanosheets, where FIG. 2A, FIG. 2B, and FIG. 2C correspond to CuBDC, ZnBDC, and CoBDC, respectively. The results in FIG. 2A to FIG. 2C demonstrate that all 3 types of two-dimensional MOFs are converted into three-dimensional morphologies, no longer retaining their original two-dimensional layered structures.

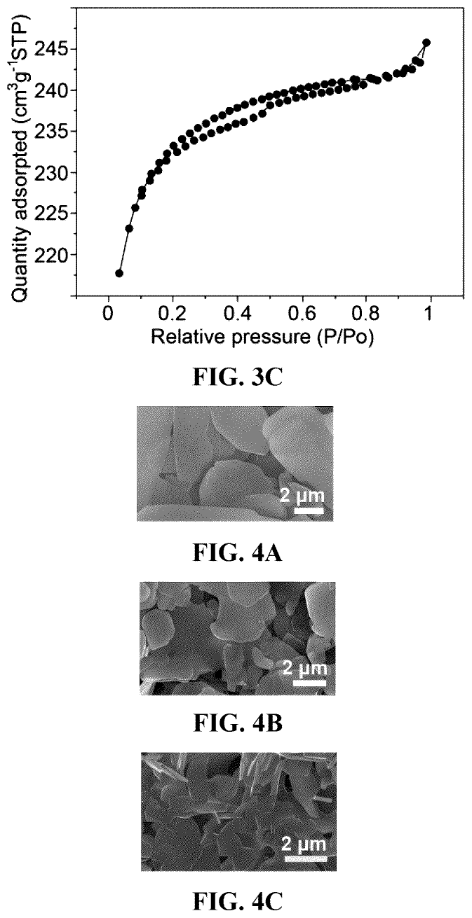

FIG. 3A shows the SEM image of three-dimensional ZnBDC, revealing that the three-dimensional ZnBDC prepared in Example 1 exhibits an octahedral morphology; FIG. 3B shows the XRD pattern of three-dimensional ZnBDC, demonstrating that the transformed structure resembles the crystal structure of MOF-5 (Zn₄O(BDC)₃); FIG. 3C shows the N₂ adsorption isotherm of three-dimensional ZnBDC, indicating that its specific surface area is 738.96 m²·g⁻¹.

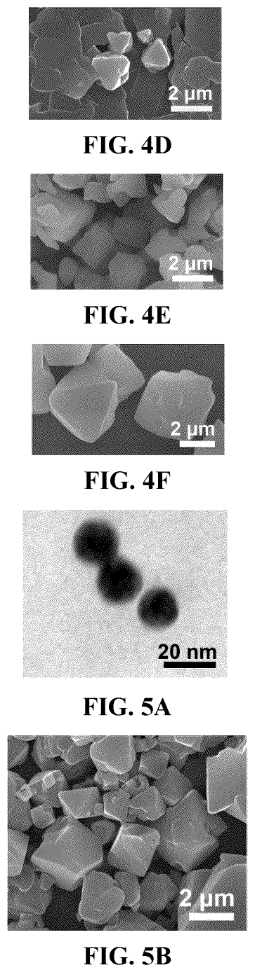

FIG. 4A to FIG. 4F shows the SEM images tracking the dual-solvent transformation process of ZnBDC over time, where FIG. 4A, FIG. 4B, FIG. 4C, FIG. 4D, FIG. 4E, and FIG. 4F correspond to 0 h, 2 h, 4 h, 6 h, 12 h, and 24 h, respectively. The results in FIG. 4A to FIG. 4F reveal that as the reaction progresses, the ZnBDC nanosheets gradually fuse, with coalescence and stacking occurring at contact points between adjacent nanosheets. By 6 h, the initial emergence of octahedral morphologies is observed. By 12 h, most structures have transformed into bulk aggregates, but their surfaces remain incomplete, with numerous small attached fragments continuing to fuse and grow. Ultimately, after 24 h, nearly all structures transform into regular octahedral configurations. This indicates that the dimensionality transformation proceeds via a fusion-based remodeling process rather than a simple dissolution-recrystallization mechanism.

### Example 2

Synthesis of 13 nm Au nanoparticles: an aqueous HAuCl₄ solution (0.01 wt. %, 150 mL) was added to a 250 mL round-bottom flask equipped with a condenser. A resulting mixture was rapidly stirred and heated until it vigorously boiled and refluxed. When boiling commenced, an aqueous trisodium citrate solution (1 wt. %, 4.5 mL) was added thereto and stirred for 20 min under reflux conditions. After a resulting solution developed a deep red color, the resulting solution was taken under high temperatures and cooled to obtain an Au nanoparticle sol. Once the Au nanoparticle sol reached room temperature, 20 mL of deionized water containing PVP (0.5 g, Mw=55,000) was added dropwise under stirring. A resulting mixture was continuously stirred at room temperature for 24 h. Post-reaction, a resulting reaction product was centrifuged, washed 3 times with methanol, and finally dispersed in methanol to obtain a methanol solution of Au nanoparticles.

1 mL of the methanol solution of Au nanoparticles was combined with 1 mL of methanol and 2 mL of DMF. After thorough mixing, 10 mg of the two-dimensional ZnBDC nanosheets prepared in Example 1 was added thereto. A resulting mixture was reacted statically in an oven at 80° C. for 24 h. A resulting reaction product was centrifuged, washed 3 times with methanol, and a resulting solid phase was dried to obtain three-dimensional ZnBDC encapsulating Au nanoparticles.

The Au nanoparticles loading in the three-dimensional ZnBDC was determined to be 8 wt. %.

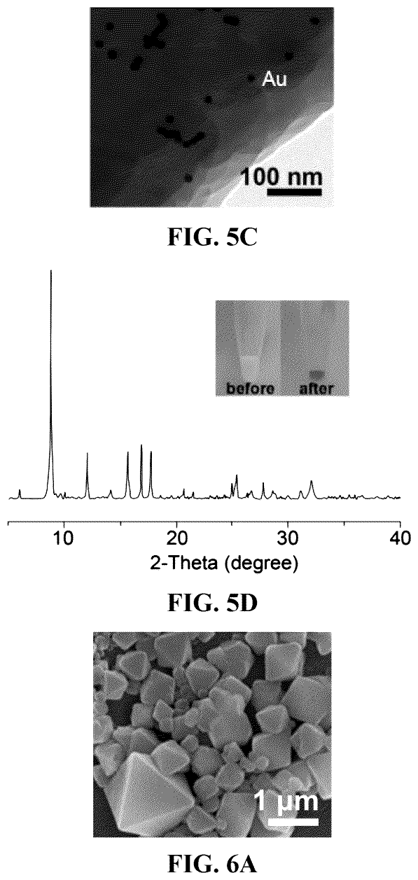

FIG. 5A shows the TEM image of Au nanoparticles. From FIG. 5A, it is observed that the size of Au nanoparticles is approximately 13 nm; FIG. 5B shows the SEM image of three-dimensional ZnBDC MOF encapsulating Au nanoparticles. From FIG. 5B, it is noted that the morphology of the three-dimensional MOF remains unaffected after nanoparticle encapsulation; FIG. 5C shows the TEM image of three-dimensional ZnBDC encapsulating Au nanoparticles. From FIG. 5C, it is confirmed that the nanoparticles exist within the MOF structure; FIG. 5D shows the XRD pattern of three-dimensional ZnBDC encapsulating Au nanoparticles, with the inset showing optical photographs of centrifuged conversion products from samples with and without encapsulated Au nanoparticles. From FIG. 5D, it is demonstrated that the light absorption of the entire composite changes after nanoparticle encapsulation, turning into a uniform gray color.

### Example 3

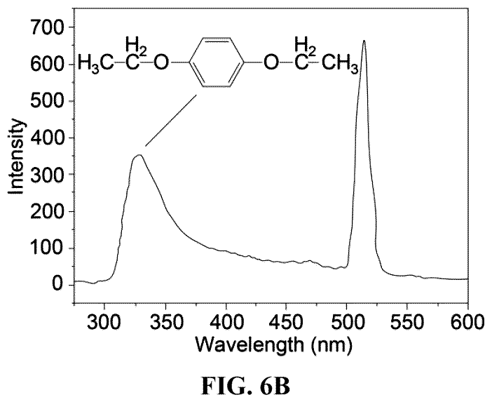

2 mg of p-diethoxybenzene was dissolved in a mixed solvent of 2 mL methanol and 2 mL DMF. After thorough mixing, 10 mg of an obtained two-dimensional ZnBDC nanosheets was added thereto. A resulting mixture was placed in an 80° C. oven and reacted statically for 24 h. A resulting reaction product was washed with DMF and ethanol, centrifuged, and collected. An obtained solid phase was dried to obtain three-dimensional ZnBDC encapsulating p-diethoxybenzene.
FIG. 6A shows the SEM image of three-dimensional ZnBDC encapsulating p-diethoxybenzene. From FIG. 6A, it is observed that the morphology of the three-dimensional MOF remains unaffected after p-diethoxybenzene encapsulation; FIG. 6B shows the fluorescence spectrum of three-dimensional ZnBDC encapsulating p-diethoxybenzene under detection conditions of an excitation wavelength of 255 nm and a test concentration of 5 mg L⁻¹. The peak at 520 nm corresponds to the absorption of three-dimensional ZnBDC. This spectrum confirms the presence of p-diethoxybenzene, indicating that this strategy achieves effective encapsulation of small organic molecules.

Tests reveal that the loading capacity of p-diethoxybenzene in the three-dimensional ZnBDC is 5 wt. %.

The above examples specifically described the encapsulation of Au nanoparticles and p-diethoxybenzene. The encapsulation methods for other metallic nanoparticles (e.g., Pt nanoparticles, Pb nanoparticles) or molecules (such as bromophenol blue) follow the same procedure and are not elaborated further.

Although the present disclosure is described in detail in conjunction with the foregoing embodiments, they are only a part of, not all of, the embodiments of the present disclosure. Other embodiments can be obtained based on these embodiments without inventive efforts, and all of these embodiments shall fall within the scope of the present disclosure.

What is claimed is:

1. A method for dimensional transformation of a metal-organic framework (MOF), comprising:
introducing a two-dimensional-layered MOF in a mixed solvent and heating to obtain a three-dimensional MOF; wherein
an organic ligand of the two-dimensional-layered MOF is selected from the group consisting of 1,4-benzenedicarboxylic acid and 2-hydroxyterephthalic acid;
a metal ion of the two-dimensional-layered MOF is selected from the group consisting of Zn²⁺, Co²⁺, and Cu²⁺; and
the mixed solvent comprises alcohol and N,N-dimethylformamide (DMF).

2. The method of claim 1, wherein the alcohol is selected from the group consisting of methanol, ethanol, and n-propanol.

3. The method of claim 1, wherein a volume ratio of the alcohol to the DMF is in a range of 0.5:1 to 3:1.

4. The method of claim 3, wherein the volume ratio of the alcohol to the DMF is 1:1.

5. The method of claim 1, wherein the heating is conducted at a temperature of 30° C. to 100° C. for 12 hours to 48 hours.

6. A process for encapsulating nanoparticles using the method for dimensional transformation of the MOF of claim 1, comprising:
mixing the two-dimensional-layered MOF, the nanoparticles, and the mixed solvent to obtain a dispersion; and
standing the dispersion, and then heating to obtain a nanoparticle-encapsulated three-dimensional MOF; wherein
the organic ligand of the two-dimensional-layered MOF is selected from the group consisting of the 1,4-benzenedicarboxylic acid and the 2-hydroxyterephthalic acid;
the metal ion of the two-dimensional-layered MOF is selected from the group consisting of the Zn²⁺, the Co²⁺, and the Cu²⁺;
the mixed solvent comprises the alcohol and the DMF; and
the nanoparticles have an average particle size less than 20 nm.

7. The process of claim 6, wherein the nanoparticles are at least one selected from the group consisting of metal nanoparticles, an organic fluorescent molecule, and a metal compound.

8. The process of claim 7, wherein the metal nanoparticles are at least one selected from the group consisting of Au nanoparticles, Pt nanoparticles, and Pb nanoparticles.

9. The process of claim 7, wherein the organic fluorescent molecule is at least one selected from the group consisting of Rhodamine B, perylene, p-diethoxybenzene, and bromophenol blue.

10. A nanoparticle-encapsulated three-dimensional MOF prepared by the process of claim 6, wherein the nanoparticle-encapsulated three-dimensional MOF comprises the three-dimensional MOF and the nanoparticles that are distributed in porous cavities and channels of the three-dimensional MOF.

11. The method of claim 2, wherein a volume ratio of the alcohol to the DMF is in a range of 0.5:1 to 3:1.

12. The process of claim 6, wherein the alcohol is selected from the group consisting of methanol, ethanol, and n-propanol.

13. The process of claim 6, wherein a volume ratio of the alcohol to the DMF is in a range of 0.5:1 to 3:1.

14. The process of claim 13, wherein the volume ratio of the alcohol to the DMF is 1:1.

15. The process of claim 6, wherein the heating is conducted at a temperature of 30° C. to 100° C. for 12 hours to 48 hours.

16. The nanoparticle-encapsulated three-dimensional MOF of claim 10, wherein the nanoparticles are at least one selected from the group consisting of metal nanoparticles, an organic fluorescent molecule, and a metal compound.

17. The nanoparticle-encapsulated three-dimensional MOF of claim 16, wherein the metal nanoparticles are at least one selected from the group consisting of Au nanoparticles, Pt nanoparticles, and Pb nanoparticles.

18. The nanoparticle-encapsulated three-dimensional MOF of claim 16, wherein the organic fluorescent molecule is at least one selected from the group consisting of Rhodamine B, perylene, p-diethoxybenzene, and bromophenol blue.
